(19) United States
(12) Patent Application Publication
(10) Pub. No.: US 2005/0195888 A1
(43) Pub. Date: Sep. 8, 2005

(54) CARRIER FREQUENCY OFFSET ESTIMATION IN PREAMBLED SYSTEMS

(76) Inventor: Wen-Sheng Hou, Tao-Yuan Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,462

(22) Filed: Mar. 5, 2004

(51) Int. Cl. H04B 1/707

(52) U.S. Cl. 375/148

(57) ABSTRACT

A device and method for improving carrier frequency offset estimation in any in constant-period DSSS system in the presence of multipath channels and thermal noise. The method includes first determining the main-cursor path from the matched code output utilizing peak detection. The main-cursor signal is then multiplied by a delayed conjugated version of the main-cursor signal. The carrier frequency offset can then be estimated from the result of the multiplication according to predefined formulas. A device capable of carrier frequency offset estimation includes control circuitry and a transceiver. The control circuitry includes a CPU and a memory. The memory includes program code utilized to implement carrier offset estimation according to the claimed invention.

### BACKGROUND OF INVENTION

1. Field of the Invention

The present invention relates to frequency offset estimation in a wireless communications system. More specifically, the present invention discloses a method of estimating carrier frequency offset in constant-period, Direct Sequence Spread Spectrum systems in the presence of multipath channels and thermal noise.

2. Description of the Prior Art

Unlike most other communications systems, spread spectrum techniques modulate a carrier signal utilizing a pseudorandom noise (PN) signal in addition to one or more data signals. In Direct Sequence Spread Spectrum (DSSS) systems, the bit rate of the PN signal (known as the “chip rate”) is chosen to be higher than the bit rate of the data signals. As a result, when the carrier signal is modulated by both the PN and data signals, the spectrum of the carrier signal is spread over a wide bandwidth, providing protection against interference, multipath, fading, jamming, and interception, making such techniques highly suitable for modern cellular phones and other communications devices.

In a wireless DSSS system, the baseband spectrum is up-converted to a suitable carrier frequency at the transmitter utilizing a first local oscillator, while the receiver performs a down-conversion on the received signal utilizing a second local oscillator to obtain the original baseband spectrum. Imperfections in the transmitters and the receivers local oscillators result in a carrier offset. This carrier offset, if left uncorrected, results in a continuous rotation in the signal constellation and therefore must be well compensated for in order to provide error-free detections at the receiver.

A variety of carrier frequency offset estimation methods have been widely used. In these methods, a preamble is used to estimate the carrier offset. For example, a DSSS preamble is a series of Barker-11 sequences transmitted with a chip rate of 11 MHz having a fundamental period of 1 μs. The receiver estimates the carrier offset according to the sequences in the received preamble. However, these conventional methods will fail when the preamble signal cannot be accurately identified. Additionally, conventional methods which utilize only a positive phase signal are unable to properly function in a bi-phase system.

### SUMMARY OF INVENTION

It is therefore a primary objective of the claimed invention to provide a device and method for improving carrier frequency offset estimation in any constant-period, preambled communication system in the presence of multipath channels and thermal noise. It is another objective of the claimed invention to provide carrier frequency offset estimation in a constant-period, preambled communication system without requiring an identifiable preamble. Furthermore, it is another objective of the claimed invention to provide carrier frequency offset estimation in a constant-period, preambled communication system utilizing a bi-phase signal.

The claimed invention begins carrier frequency offset estimation by determining the main-cursor path from the matched code output utilizing peak detection. The main-cursor signal is then multiplied by a delayed conjugated version of the main-cursor signal. The carrier offset can then be estimated from the result of the multiplication according to predefined formulas.

A claimed device capable of carrier frequency offset estimation includes control circuitry and a transceiver. The control circuitry includes a CPU and a memory. The memory includes program code utilized to implement carrier offset estimation according to the claimed invention.

Carrier frequency offset estimation according to the claimed invention can be used in any in constant-period DSSS system in the presence of multipath channels and thermal noise. Identical signals in the preamble are not necessary and the claimed invention is able to function properly in a bi-phase system.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a block-functional diagram of a DSSS system.

FIG. 2 illustrates a simplified DSSS system aproximately equivalent to that of FIG. 1.

FIG. 3 is a list of equations utilized for frequency offset estimation according to the present invention.

FIG. 4 is a flow chart carrier frequency offset estimation according to the present invention.

FIG. 5 is a DSSS device according to the present invention.

### DETAILED DESCRIPTION

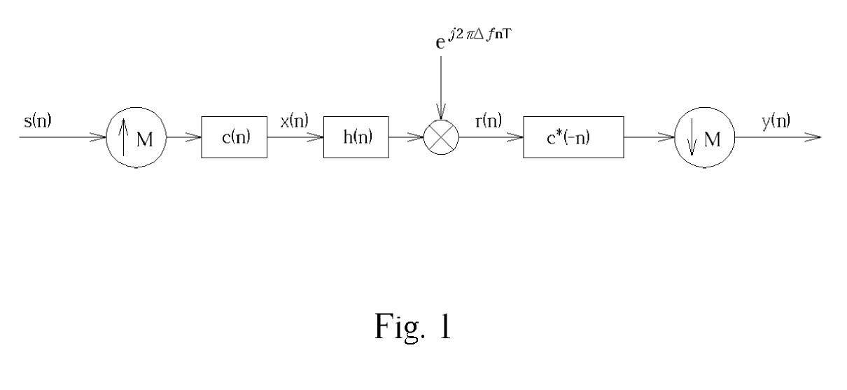

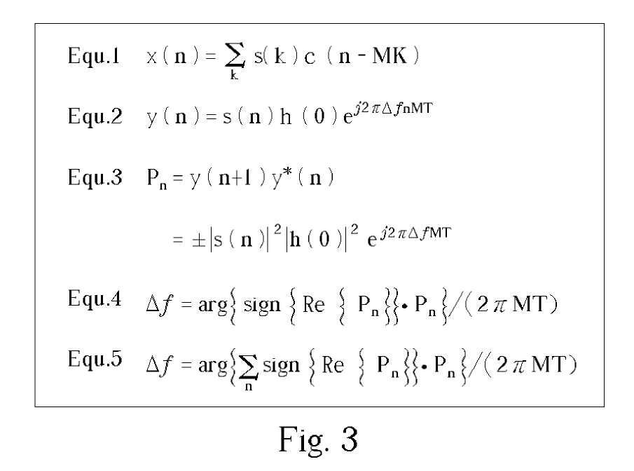

Please refer to FIG. 1, which illustrates a baseband Direct Sequence Spread Spectrum (DSSS) system. In FIG. 1, s(n) represents a binary phase-shift keying (BPSK) signal, M is the spreading factor, c(n) is the pseudorandom noise (PN) spreading code, h(n) is the multipath channel, Δf is the carrier offset, and T is the chip interval. In this system, the preamble spreading signal of x(n) is obtained by equation 1 shown in FIG. 3.

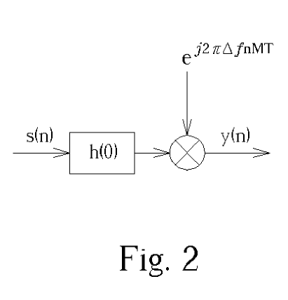

If
c(n) [symbol] (c*(+n)e [symbol] )≈ [symbol] (n)
is the delta function, then the DSSS system of FIG. 1 can be simplified to FIG. 2. In FIG. 2, h(0) is the main-cursor path of the multipath channel and can be found by peak detection. The matched code output, y(n), is calculated according to equation 2 of FIG. 3 and can be utilized to estimate the frequency offset Δf.

Assuming that s(n+1)s*(n)=
±|s(n)|²
for s(n) in the BPSK signal, a first result (Pₙ) of multiplying the signal y(n) by a delayed conjugated version of y(n), can be calculated as shown in equation 3 of FIG. 3. Obviously, it may be possible to obtain an alternative first result by multiplying a delayed signal y(n) by an un-delayed conjugated version of y(n) without departing from the spirit of the invention. Because

$$- \frac{π}{2} << 2πΔ fMT \frac{<< π}{2}$$

for a small frequency offset Δf, then Δf can be estimated by equations 4 and/or 5 of FIG. 3. In equations 4 and 5, arg { . . . } is an argument function representing the phase of Pₙ and has a value ranging from −π to +π, Re{ . . . } is a real part function, and sign{ . . . } is the sign function. It is preferred but not necessary to combine several Pₙs as shown in equation 5 of FIG. 3 for an improved signal-to-noise ratio. Once the carrier offset Δf has been calculated, appropriate methods can be taken to provide error-free detections at the receiver.

The use of both the arg{ . . . } and the sign function allows offset estimation on a positive and negative phase BPSK signal. For example, if the argument to the sign function falls in the 2^{nd} or 3^{rd} quadrant, the result is effectively flipped by 180 degrees back into the 1^{st} or 4^{th} quadrants respectively.

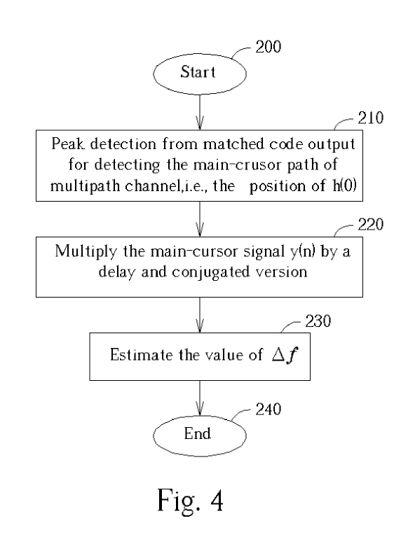

FIG. 4 illustrates a flow chart of essential steps for carrier offset estimation according to the present invention.

Step 200: Start carrier offset estimation.

Step 210: Determine the main-cursor path h(0) from the matched code output y(n) utilizing peak detection.

Step 220: Multiply the main-cursor signal y(n) by a delay and conjugated version of y(n) as shown in equation 3.

Step 230: Estimate the carrier offset Δf as shown in equation 4 or equation 5.

Step 240: End carrier offset estimation.

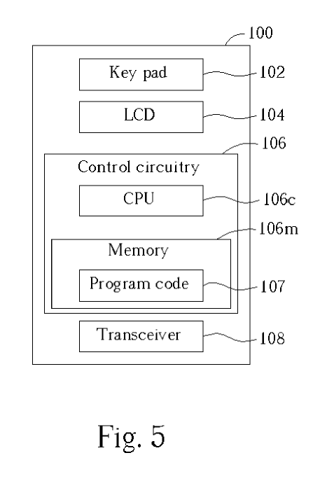

FIG. 5 is a block diagram of a DSSS device 100 according to the present invention. The device 100 comprises control circuitry 106 and a transceiver 108 and may optionally comprise a key pad 102 for entering user data and an LCD 104 according to design considerations. The control circuitry 106 comprises a CPU 106c for controlling operations of the device 100 and a memory 106m. The memory 106m comprises program code 107 utilized to implement carrier offset estimation according to the present invention. The program code 107 may include any or all of the formulas shown in FIG. 3 as well as code pertaining to their appropriate application. The transceiver 108 is used to send and/or receive communications between the device 100 and another DSSS device (not shown).

Compared to the prior art, carrier frequency offset estimation according to the present invention can be used in any in constant-period DSSS system in the presence of multipath channels and thermal noise. Identical, identifiable signals in the preamble are no longer necessary. Additionally, unlike conventional methods which utilize only a positive phase signal, the present invention is able to function properly in a bi-phase system.

Those skilled in the art will readily observe that numerous modifications and alterations of the device and method may be made while retaining the teachings of the invention. For example, the teachings of this disclosure are not intended to limit the scope of the present invention to a DSSS system. The teachings of the present invention are intended to apply to any constant-period preambled communication system. Accordingly, the above disclosure should be construed as limited only by the metes and bounds of the appended claims.

1. A method of estimating carrier frequency offset in a constant-period, preambled wireless communications system, the method comprising:
determining a main-cursor signal corresponding to a main-cursor path from a matched code output;
multiplying the main-cursor signal by a delayed conjugated version of the main-cursor signal to obtain a first result; and
estimating the carrier frequency offset according to a predefined formula utilizing the first result.

2. The method of claim 1 wherein the main-cursor signal is determined using peak-detection.

3. The method of claim 1 wherein the predefined formula includes multiplying a phase of the first result by the sign of a real part of the first result.

4. The method of claim 3 wherein the main-cursor signal is a BPSK signal.

5. The method of claim 1 wherein the communications system is a DSSS wireless communications system.

6. A device for use in a constant-period, preambled wireless communications system, the device comprising:
a transceiver for wirelessly communicating with another communications device within the communications system; and
control circuitry connected to the transceiver, the control circuitry comprising a CPU and a memory, the memory comprising:
program code capable of causing a main-cursor signal corresponding to a main-cursor path to be determined from a receivers matched code output;
program code capable of causing the main-cursor signal to be multiplied by a delayed conjugated version of the main-cursor signal to obtain a first result;
program code comprising at least a predefined formula; and
program code capable of causing a carrier frequency offset to be estimated according to the predefined formula utilizing the first result.

7. The device of claim 6 wherein the main-cursor signal is determined using peak-detection.

8. The device of claim 6 wherein the predefined formula includes multiplying a phase of the first result by the sign of a real part of the first result.

9. The device of claim 6 wherein the main-cursor signal is a BPSK signal.

10. The device of claim 6 further comprising a keyboard and LCD.

11. The device of claim 6 wherein the communications system is a DSSS wireless communications system.
